(19) United States
(12) Patent Application Publication
(10) Pub. No.: US 2011/0109069 A1
(43) Pub. Date: May 12, 2011

(54) AIRBAG MODULE FOR A VEHICLE

(75) Inventor: Ulrich Rick, Braunweiler (DE)

(73) Assignee: GM GLOBAL TECHNOLOGY OPERATIONS, INC., Detroit, MI (US)

(21) Appl. No.: 12/942,924

(22) Filed: Nov. 9, 2010

(30) Foreign Application Priority Data
Nov. 10, 2009 (DE) 102009052565.3

(51) Int. Cl. B60R 21/26

(52) U.S. Cl. 280/736

(57) ABSTRACT

An airbag module is provided for a vehicle, including, but not limited to an airbag including, but not limited to a gas filling device, which has at least two outflow openings through which the gas flows into the airbag. The at least two outflow openings adapted such that a majority of the gas flows in a thrust-neutral and/or force-neutral manner into the airbag.

### CROSS-REFERENCE TO RELATED APPLICATION

This application claims priority to German Patent Application No. 102009052565.3, filed Nov. 10, 2009, which is incorporated herein by reference in its entirety.

### TECHNICAL FIELD

The technical field relates to an airbag module for a vehicle having an airbag and having a gas filling device, which has at least two outflow openings, through which the gas flows into the airbag.

### BACKGROUND

Airbag modules are typically installed in vehicles to protect vehicle occupants in the event of an impact of the vehicle. Airbag modules which comprise an airbag and a gas filling device are known. In the event of an activation of the airbag module, gas flows out of the gas filling device into the airbag, upon which the airbag unfolds in the direction of the vehicle occupants.

The publication DE 10 2006 057 503 A1 describes an airbag configuration for a motor vehicle having a motor vehicle module, which has an airbag and a gas generator for inflating the airbag. The airbag module is situated, without airbag module housing, inside a firing channel housing, which allows targeted unfolding of the airbag. The firing channel housing is closed on the passenger side using a cover, which is connected to the firing channel housing via an intended break line. The airbag and/or a flexible protective envelope that at least partially envelops the airbag are connected to the firing channel housing in such a manner that the airbag or the protective envelope contacts the firing channel housing.

The publication DE 20 2007 018 451 U1, which is considered to form the closest prior art, relates to an inflation device of an airbag assembly for a motor vehicle. The inflation device comprises a gas generator to release gases to fill an airbag, an exit area of the gas generator, from which the gases released to fill the airbag exit, and a diffuser, which encloses the gas generator in a ring shape and defines gas conduction channels, which conduct the gases into the airbag. The directions in which the gases are conducted correspond, in particular, in the same direction.

In view of the foregoing, at least one object includes providing an airbag module that is implemented with reduced weight, cost-effectively, and conforming to licensing. In addition, other objects, desirable features and characteristics will become apparent from the subsequent summary and detailed description, and the appended claims, taken in conjunction with the accompanying drawings and this background.

### SUMMARY

According to an embodiment of the invention, an airbag module is proposed for a vehicle, in particular for an automobile. The airbag module is preferably implemented as a passenger airbag. The airbag module comprises an airbag and a gas filling device. The airbag is implemented for the purpose of being filled with gas upon an activation of the airbag module, in particular upon an impact of the vehicle, and preferably unfolding in the direction of a vehicle occupant, in particular in the direction of the passenger. The impact of the vehicle occupants can thus be absorbed and the occupants can be protected from injuries.

The gas filling device is preferably implemented for the purpose of providing the gas for filling the airbag. In particular, the gas filling device comprises an electrical line, an ignition unit, and a body which has one or more cavities. Upon the activation of the airbag module, ignition occurs in the ignition unit through an electrical pulse via the electrical line, whereby a chemical reaction is triggered, which generates the gas. The gas propagates in the cavity/cavities.

The gas filling device is implemented for the purpose of causing the gas to flow from the cavity/cavities into the airbag and/or conducting the gas into the airbag. The gas filling device preferably has at least one partition layer, which at least partially spatially partitions the gas filling device from the airbag. For example, the partition layer can be implemented as a body wall of the body. It is also possible that the partition layer or multiple partition layers at least partially, preferably radially, enclose/encloses the body wall. In this case, a flow area is formed between the body wall and the partition layer. A flow area can also optionally be formed between the two or more partition layers.

The gas filling device has at least two outflow openings, through which the gas flows into the airbag. The at least two outflow openings are preferably situated in the body wall or the partition layer, which directly adjoins an interior of the airbag, more precisely a free volume of the airbag. The outflow openings are especially implemented for the purpose of providing a direct flow connection between the gas filling device and the interior of the airbag or the free volume of the airbag. For example, the outflow openings may be implemented as a circular, oval, or polygonal passage in the body wall or in the partition layer. It is also possible that the outflow openings comprise an array of passages, in which multiple passages are situated arrayed at regular or irregular intervals from one another.

It is also conceivable that the outflow openings are implemented as a slot, whose length is significantly longer than its width. It is conceivable that the slot is implemented as continuous or having interruptions. For example, the slot can be implemented like a raster. Furthermore, it is possible that the outflow openings can be implemented as an outflow opening area.

If the gas flows directly or without bypasses from the body into the airbag or into the free volume of the airbag, the outflow openings are situated in the body wall. The gas filling device preferably does not comprise a further partition layer in this implementation. The body wall particularly directly adjoins the airbag and/or the free volume of the airbag.

If the gas first flows from the body into one or more flow areas, the body wall preferably has one or more gas outlets, through which the gas reaches the flow area/areas from the body and/or is conducted and/or flows. In particular, the partition layer, which delimits the flow area toward the interior of the airbag or to the free volume of the airbag, has the at least two outflow openings.

According to an embodiment of the invention, the at least two outflow openings are situated and/or implemented in such a manner that at least a majority of the gas flows in a thrust-neutral and/or force-neutral manner into the airbag. The airbag module is preferably not moved or is only moved to a small extent due to the thrust-neutral and/or force-neutral configuration of the outflow openings.

The cited publications DE 10 2006 057 503 A1 and DE 20 2007 018 451 U1 describe airbag modules which are implemented as subject to thrust because of the forces caused by the flow of the gases into the airbag. One consideration of the embodiments of the invention is that typical airbag modules normally have an airbag module housing that represents a fastening interface to the vehicle and a thrust and/or force neutrality of the airbag module can thus be ensured.

An airbag module housing can be dispensed with through the embodiments of the present invention and the thrust and/or force neutrality can nonetheless be ensured. Dispensing with the airbag module housing advantageously results in significant weight reductions, which in turn can have a positive effect on fuel consumption and emission values of the vehicle. Furthermore, the costs for the provision and installation of the airbag module can be saved, and a significant cost reduction of the airbag module and also the vehicle can thus be made possible. Furthermore, because of smaller packing units, storage costs may be saved.

In one possible embodiment of the invention, the at least two outflow openings are situated in such a manner that at least approximately 70%, preferably at least approximately 80%, in particular at least approximately 90% of the gases flow into the airbag in a thrust-neutral and/or force-neutral manner. The outflow openings are preferably situated in such a manner that at least approximately 70%, preferably at least approximately 80%, in particular at least approximately 90% of the sum of all forces that are generated by a mass and/or volume flow of the gas into the airbag and/or through its flow velocity is zero or nearly zero.

In particular, the gas filling device is implemented in such a manner that at least approximately 70%, preferably at least approximately 80%, in particular at least approximately 90% of the sum of all force vectors which result from the flow of the gas into the airbag mutually cancel out and/or neutralize one another. The force vectors are preferably two gas flows which neutralize or extensively neutralize one another in their force, in particular thrust force, and which flow through two outflow openings into the airbag, are situated on a shared straight line, and have opposing directions. In particular, the shared straight line runs through a center point and/or center of gravity of the body and/or the partition layer.

It is also conceivable that one force vector of a first gas flow into the airbag neutralizes or extensively neutralizes the force vectors of a second, third, and one or more additional gas flows into the airbag. This can be the case in particular if the mass and/or volume flow and/or the velocity of the first gas flow corresponds or is similar to the sum of the mass and/or volume flow and/or the velocity of the second, third, and the further gas flow or flows into the airbag. The direction of the first force vector is preferably oriented opposite to the direction of the second, third, and the further force vector or vectors.

A preferred exemplary embodiment provides that the gas filling device, in particular the body or the partition layer, has the center of gravity in a cross-sectional view, through which the at least one imaginary straight line runs, which intersects the gas filling device, in particular the body wall or the partition layer, in at least two intersection points, the outflow openings being situated in the intersection points and/or at the height of the intersection points. The outflow openings are preferably situated in a mirror image to an imaginary line through the center of gravity and/or the center point of the body or the partition layer. In particular, the outflow openings are situated in a mirror image to a center plane, which divides the body or the partition layer centrally into two equal parts. The outflow openings are especially distributed geometrically uniformly over the gas filling device, in particular over the body wall or the partition layer.

It is particularly preferred that the gas filling device, in particular the body and/or the partition layer, have the form of a cylinder or a prism, the cylinder and/or the prism comprising a lateral surface and a base and cover surface or an imaginary base and cover surface. It is also conceivable that the gas filling device, in particular the body and/or the partition layer, has the form of a sphere, a balloon, or a cube. It is obvious that all other forms or designs are also possible.

In a further possible design of the invention, a first of the outflow openings is situated radially to a straight line through the center points of the ground and cover surfaces in the peripheral direction at an angle of beta degrees and a second of the outflow openings is situated at an approximately angle of (beta+180) degrees on the lateral surface. Arbitrarily many (n) outflow openings may preferably be situated on the lateral surface, these being able to be situated radially to the straight line through the center points of the base and cover surfaces in the peripheral direction at angles of approximately a and approximately (a+180) degrees, approximately j and approximately (j+180) degrees, approximately d and approximately (d+180) degrees, etc.

A further embodiment of the invention provides that the gas filling device, in particular the body and/or the partition layer, is implemented as a right circular cylinder having two circular surfaces as the base and cover surfaces and having a cylindrical lateral surface. The cylindrical lateral surface has two outflow openings, for example. These are preferably situated in the peripheral direction radially to a straight line through the center points of the circular surfaces at angles of approximately 90° and approximately 270° on the cylindrical lateral surface.

It is also conceivable that the cylindrical lateral surface has more than two outflow openings. These are preferably situated in the peripheral direction radially to the straight lines through the center points of the circular surfaces at angles of approximately 45° and approximately 225°, approximately 135° and approximately 315°, approximately 180° and approximately 360°, etc. However, other configurations of the outflow openings at angles other than those already proposed are also possible.

In a further possible implementation of the invention, the gas filling device comprises a gas generator having a gas generator jacket, the gas generator jacket having the at least two outflow openings. The gas generator preferably corresponds to the body and the gas generator jacket corresponds to the body wall or the gas generator jacket is formed by the body wall.

Another embodiment of the invention provides that the gas filling device comprises an envelope. The envelope preferably has the at least two outflow openings. In particular, the envelope at least partially envelops the gas generator jacket. The envelope especially radially envelops the gas generator jacket. The envelope preferably corresponds to the one or more of the partition layers. The envelope is especially implemented as a diffuser. The diffuser is typically implemented for the purpose of slowing a velocity of the gas flow and increasing a gas pressure in the gas filling device.

In another embodiment of the invention, the gas generator is implemented as a right circular cylinder having two circular surfaces as base and cover surfaces. The circular cylinder preferably has the at least two outflow openings on its lateral surface. The outflow openings are situated radially to straight lines through the center points of the circular surfaces, for example. In particular, the outflow openings are situated at intermediate angles of approximately 90° or approximately 180° on the lateral surface.

In the implementation as the right circular cylinder, the gas generator preferably directly adjoins the interior of the airbag and/or the free volume of the airbag. In particular, the gas can flow directly into the airbag without bypasses. The gas generator especially has no envelope, which encloses and/or envelops it, in the implementation as the right circular cylinder.

In another embodiment of the invention, the envelope is implemented as a right prism having two octagons as the base and cover surfaces. The envelope preferably has the at least two outflow openings on its lateral surface. In particular, the outflow openings are situated radially in the peripheral direction to a straight line through the center points of the octagons. The outflow openings are especially situated at intermediate angles of approximately 90° or approximately 180° on the lateral surface of the prism.

In the implementation as the right prism, the envelope preferably completely encloses and/or envelops the gas generator, in particular the gas generator jacket, radially and forms a flow area between the gas generator jacket and the envelope. In particular, the gas reaches the flow area from the gas generator through the at least one gas outlet. The envelope especially directly adjoins the interior of the airbag and/or the free volume of the airbag in the implementation as the right prism, the gas flowing through the outflow openings directly into the airbag, in particular without bypasses.

### BRIEF DESCRIPTION OF THE DRAWINGS

The present invention will hereinafter be described in conjunction with the following drawing figures, wherein like numerals denote like elements, and:

FIG. 1 shows a perspective view of a gas filling device;

FIG. 2 shows a top view of the gas filling device from FIG. 1;

FIG. 3 shows a section along section line Z-Z through the gas filling device from FIG. 2;

FIG. 4 shows an alteration of the section through the gas filling device from FIG. 3;

FIG. 5 shows a variant of the gas filling device from FIG. 1;

FIG. 6 shows a section through the gas filling device from FIG. 5; and

FIG. 7 shows a section through a further alteration of the gas filling device from FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

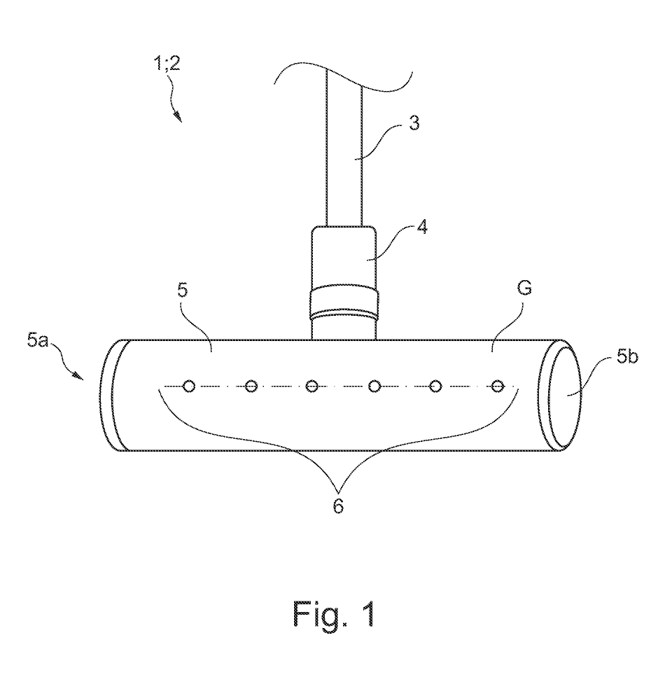

A possible exemplary embodiment of the invention is shown in FIG. 1, which shows a perspective view of an airbag module having a gas filling device 1. The gas filling device 1 is implemented as a gas generator 2. The gas generator 2 has an electrical line 3, an igniter 4, and a gas generator jacket 5. The gas generator jacket 5 is implemented as a hollow cylinder and has two circular surfaces 5a, 5b as the base and cover surfaces of the hollow cylinder. An outflow opening 6 is situated in each case on a visible side G of the gas generator jacket 5 and on an opposite side (not visible). The outflow openings 6 each comprise six circular passages in the gas generator jacket 5, which are arrayed in a line in the longitudinal direction (from the base surface to the cover surface of the hollow cylinder) of the gas generator jacket 5.

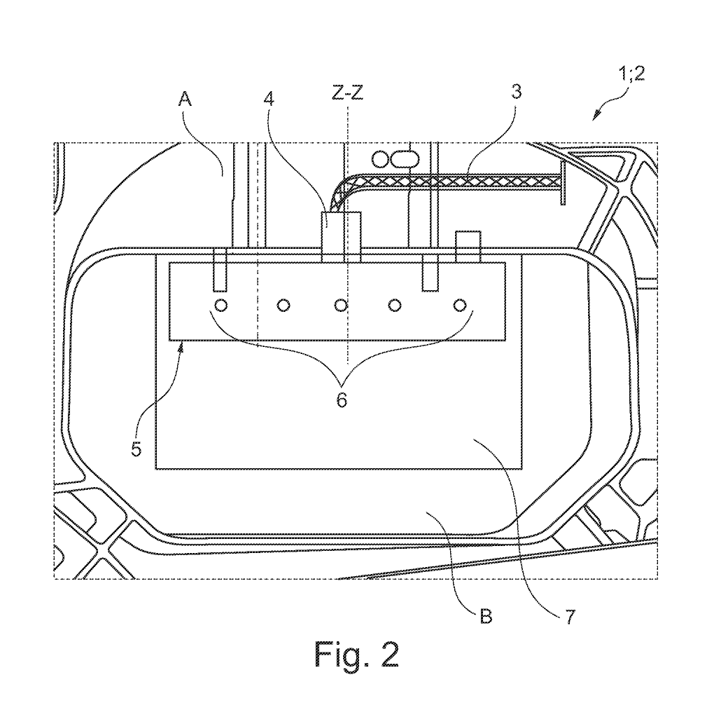

FIG. 2 shows a top view of the gas generator 2 from FIG. 1. The gas filling device 1 comprises an airbag 7 in an installed state, which is integrated using the gas generator 2 in a dashboard A on the passenger side of an automobile. The gas generator 2 is at least partially situated in the airbag 7, more precisely in a free volume of the airbag 7. The airbag 7 is situated in a firing channel B and is implemented for the purpose of being filled with gas and unfolding along the firing channel B in the direction of a passenger.

In the event of an activation of the airbag module, an electrical pulse occurs via the electrical line 3 to the igniter 4, which causes a chemical reaction, during which gas is generated. The outflow openings 6 are capable and implemented for the purpose of causing the gas to flow directly, without bypasses, into the free volume of the airbag 7. They are situated on the gas generator jacket 5 in such a manner that the gas flows in a thrust-neutral and/or force-neutral manner into the airbag or into the free volume of the airbag 7.

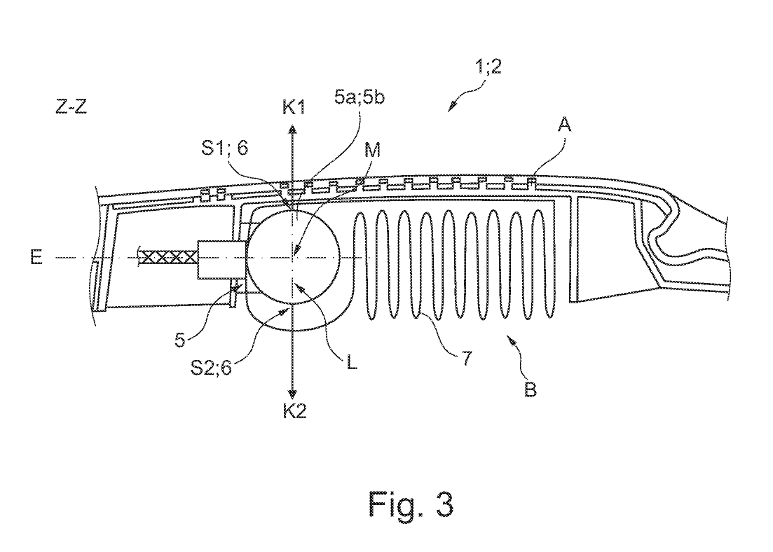

FIG. 3 shows a section along section line Z-Z through the gas filling device 1 from FIG. 2. The circular surfaces 5a, 5b each have a center point M, through which a section line L runs, which intersects the gas generator jacket 5 in two intersection points S1, S2. The outflow openings 6 are situated at the height of the intersection points S1; S2 and in mirror image to a center line E, which divides the circular surfaces 5a, 5b centrally.

The outflow openings 6 are geometrically situated on the gas generator jacket 5 in such a manner that the gas flows at least approximately 85% in a thrust-neutral and/or force-neutral manner into the airbag 7. Two force vectors K1, K2 result from the flow of the gas through the outflow openings 6, in particular from a gas volume and/or gas mass flow and/or a gas flow velocity. The force vectors K1, K2 are of equal size and/or strength, at least they differ by at most approximately 15% in their size or strength. They lie on a shared straight line, namely on the section line L, and are oriented in opposing directions, so that they cancel out and/or neutralize one another by at least approximately 85%.

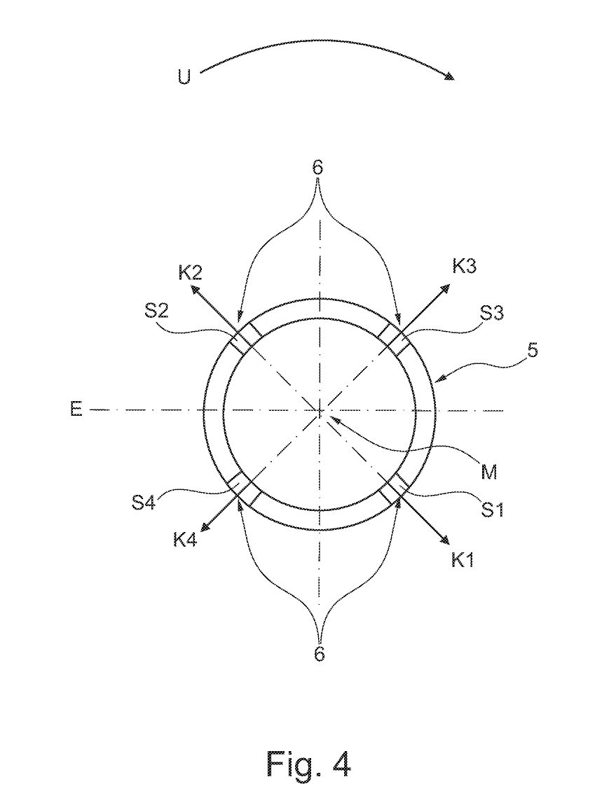

FIG. 4 shows a further exemplary embodiment of the invention. An alteration of this section through the gas generator jacket 5 from FIG. 3 is shown. The gas generator jacket 5 has four outflow openings 6. Each two of the outflow openings 6 lies on an imaginary shared straight line through the center point M. The outflow openings are situated in or at the height of the intersection points S1, S2, S3, S4 of the straight lines with the gas generator jacket 5 and are situated in a mirror image to the center line E. In the peripheral direction (according to arrow U), the outflow openings 6 are situated at intermediate angles of approximately 90°. The force vectors K1, K2 and K3, K4, which result from the gas flow through the outflow openings 6, are each on the imaginary straight lines and each have opposing directions. The force vectors K1, K2 and K3, K4 are each equal in their size or strength, with a maximum deviation of approximately 15%.

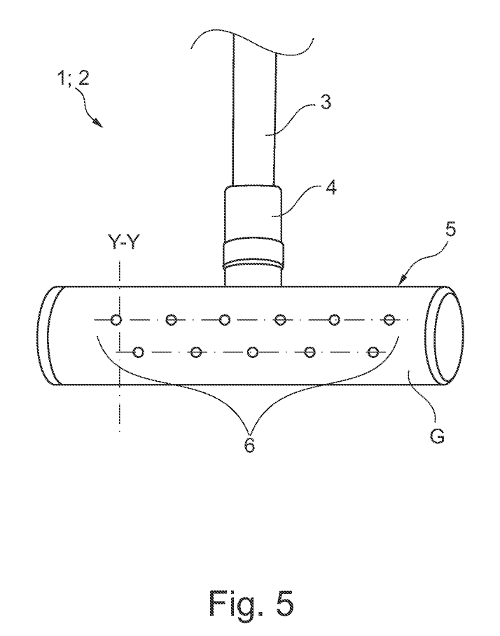

FIG. 5 shows a variant of the gas filling device 1 from FIG. 1. The gas generator jacket 5 has four outflow openings 6, two being situated on the visible side G of the gas generator jacket 5 and two being situated on the opposing side (not visible). The outflow openings 6 are situated in such a manner that the gas can flow in a force-neutral and/or thrust-neutral manner into the airbag (not shown).

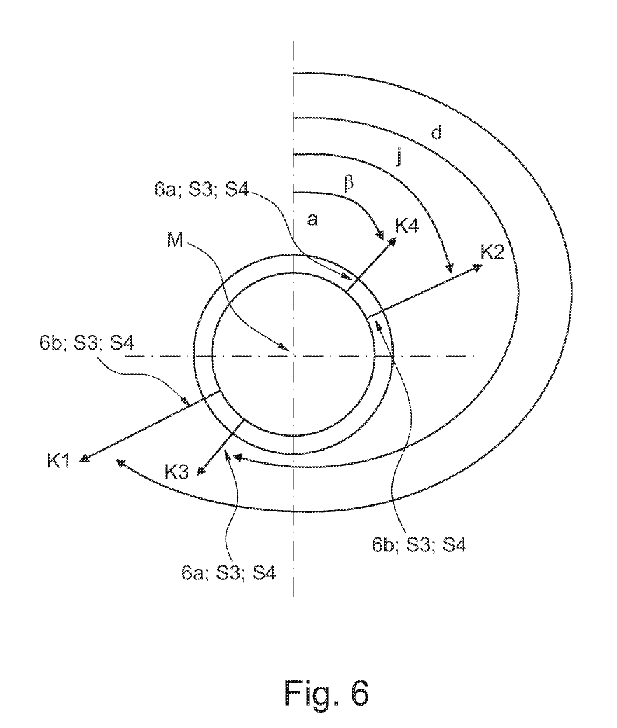

FIG. 6 shows a section along section line Y-Y through the gas generator jacket 5 from FIG. 5. The gas generator jacket 5 has four outflow openings 6, of which two outflow openings 6a are situated at angles a of approximately 30° and j of approximately 210° on the gas generator jacket 5. The outflow openings and the force vectors K3, K4, which are caused by the gas flows through the outflow openings 6a, lie on an imaginary shared straight line. The imaginary shared straight line runs through the center point M of the circular surface of the gas generator jacket 5 and intersects it at the intersection points S3, S4, in which or at the height of which the outflow openings 6a are situated. The force vectors K3, K4 have the same size and strength and mutually neutralize one another, so that the gas can flow in a force-neutral and/or thrust-neutral manner into the airbag (not shown).

The other two outflow openings 6b are situated at angles β of approximately 60° and d of approximately 240° on the gas generator jacket 5. The outflow openings 6b and also the force vectors K1, K2 of the gas flows through the outflow openings 6b lie on a further imaginary shared straight line. The force vectors K1, K2 are also oriented in opposing directions. The imaginary shared straight line runs through the center point M of the circular surface of the gas generator jacket 5 and intersects it at the intersection points S1, S2, in which or at the height of which the outflow openings 6b are situated. The force vectors K1, K2 have the same size and strength, so that they neutralize one another mutually. The gas flows in a force-neutral and/or thrust-neutral manner into the airbag.

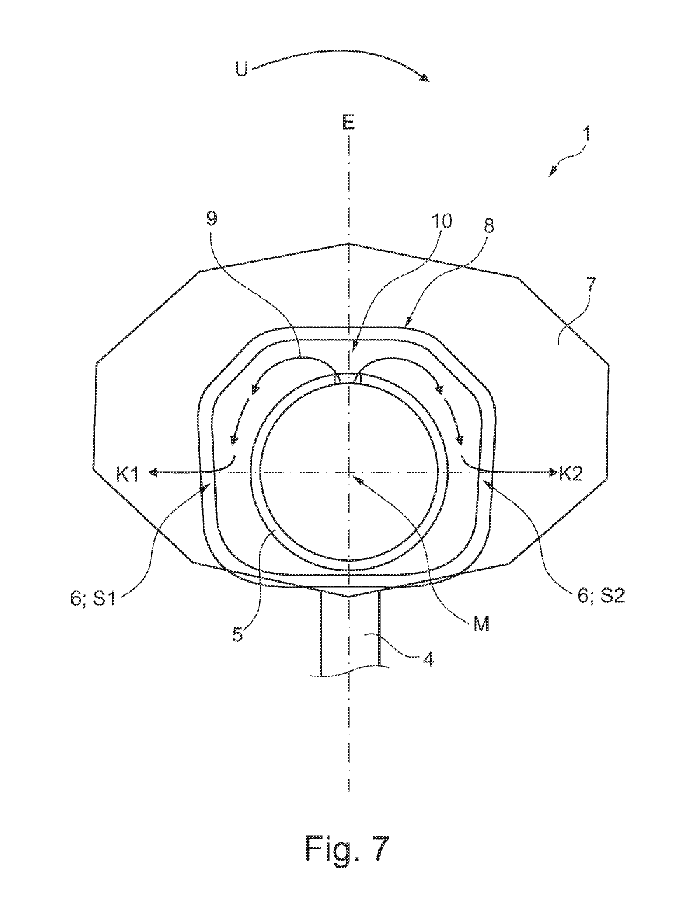

FIG. 7 shows a further exemplary embodiment of the invention. A section is shown through an alteration of the gas filling device 1 from FIG. 2. The gas filling device 1 has an envelope 8, which is implemented as a diffuser. The envelope 8 completely envelops the gas generator jacket 5 and adjoins the free volume of the airbag 7. The envelope 8 is implemented as octagonal in the sectional view and has two outflow openings 6. The outflow openings 6 are situated at an intermediate angle of approximately 180° and in a mirror image to the center line E in the peripheral direction (according to arrow U). They are situated in the intersection points S1, S2 of an imaginary straight line with the envelope 8. The straight line runs through the center point M of the envelope 8, or the octagon.

The envelope 8 forms, with the gas generator jacket 5, a flow area 9, which is situated in an intermediate space between the gas generator jacket 5 and the envelope 8. The gas generator jacket 5 has a gas outlet 10, from which gas flows into the flow area 9. The gas flows via a flow connection to the outflow openings 6. The gas flows directly through these openings, without bypasses, into the free volume of the airbag 7.

The force vectors K1, K2 are caused by the flow of the gas into the free volume of the airbag 7, in particular by the volume and/or mass flow and/or by the gas flow velocity. The force vectors K1, K2 lie on the imaginary straight line through the center point M and through the intersection points S1, S2. They are equal in size and strength with a maximum deviation of approximately 10% and are oriented in opposing directions. A majority of the gas thus flows in a thrust-neutral and/or force-neutral manner into the airbag.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An airbag module for a vehicle, comprising:
an airbag;
a gas filling device adapted to fill the airbag; and
at least two outflow openings of the gas filling device through which a gas flows into the airbag, wherein the at least two outflow openings are adapted such that a majority of the gas flows in a neutral manner into the airbag.

2. The airbag module according to claim 1, wherein the neutral manner is a thrust-neutral manner.

3. The airbag module according to claim 1, wherein the neutral manner is a force-neutral manner.

4. The airbag module according to claim 1, wherein the at least two outflow openings are adapted such that that at least approximately 70% of the gas flows in the neutral manner into the airbag.

5. The airbag module according to claim 1, wherein the at least two outflow openings are adapted such that that at least approximately 80% of the gas flows in the neutral manner into the airbag.

6. The airbag module according to claim 1, wherein the at least two outflow openings are adapted such that at least approximately 90% of the gas flows in the neutral manner into the airbag.

7. The airbag module according to claim 1, wherein the gas filling device is adapted such that at least approximately 70% of a sum of force vectors, which result from the gas flows into the airbag, substantially cancel out one another.

8. The airbag module according to claim 1, wherein the gas filling device is adapted such that at least approximately 80% of a sum of force vectors, which result from the gas flows into the airbag, substantially cancel out one another.

9. The airbag module according to claim 1, wherein the gas filling device is adapted such that at least approximately 90% of a sum of force vectors, which result from the gas flows into the airbag, substantially cancel out one another.

10. The airbag module according to claim 1, wherein the gas filling device has a center in a cross-sectional view through which at least one imaginary straight line runs and intersects the gas filling device in at least two intersection points, the at least two outflow openings situated in the at least two intersection points.

11. The airbag module according to claim 1, wherein the gas filling device has a center in a cross-sectional view through which at least one imaginary straight line runs and intersects the gas filling device in at least two intersection points, the at least two outflow openings situated at a height of the at least two intersection points.

12. The airbag module according to claim 1, wherein the gas filling device comprises a form of a cylinder, the cylinder comprising a lateral surface, a base surface, and a cover surface.

13. The airbag module according to claim 1, wherein the gas filling device comprises a form of a prism, the prism comprising a lateral surface, a base surface, and a cover surface.

14. The airbag module according to claim 12, wherein a first outflow opening is situated radially to a straight line through center points of the base surface and the cover surface in a peripheral direction at an angle of approximately beta degrees and a second of the at least two outflow openings is situated at a second angle of approximately (beta+180) degrees on the lateral surface.

15. The airbag module according to claim 14, wherein the at least two outflow openings are situated radially in the peripheral direction to the straight line through the center points of the base surface and the cover surface on the lateral surface, the at least two outflow openings situated at intermediate angles of approximately (gamma+360/n) degrees, wherein n being an even natural number and specifying a number of the at least two outflow openings.

16. The airbag module according to claim 12, wherein the gas filling device is a right circular cylinder having two circular surfaces as the base surface and the cover surface and comprising a cylindrical lateral surface, two of the at least two outflow openings situated in a peripheral direction radially to a straight line through a center point of the two circular surfaces at angles of approximately 90° and of approximately (90+180)° on the cylindrical lateral surface, wherein 0° being situated at a position of an igniter.

17. The airbag module according to claim 12, wherein the gas filling device comprises a gas generator comprising a gas generator jacket, the gas generator jacket comprising the at least two outflow openings.

18. The airbag module according to claim 17, wherein the gas filling device comprises an envelope that at least partially envelops the gas generator jacket and comprises the at least two outflow openings.

19. The airbag module according to claim 18, wherein the envelope is a diffuser.

20. The airbag module according to claim 17, the gas generator jacket is a right circular cylinder comprising two circular surfaces as the base surface and the cover surface and comprising the at least two outflow openings, the at least two outflow openings situated radially in a peripheral direction to straight lines through center points of the two circular surfaces, the at least two outflow openings situated at intermediate angles of approximately 90° on the lateral surface of the cylinder.

21. The airbag module according to claim 17, the gas generator jacket is a right circular cylinder comprising two circular surfaces as the base surface and the cover surface and comprising the at least two outflow openings, the at least two outflow openings situated radially in a peripheral direction to straight lines through center points of the two circular surfaces, the at least two outflow openings situated at intermediate angles of approximately 180° on the lateral surface of the cylinder.

22. The airbag module according to claim 13, wherein an envelope is a right prism comprising two octagons as the base surface and the cover surface and comprises the at least two outflow openings, the at least two outflow openings situated radially to a straight line through center points of the two octagons, the at least two outflow openings situated at intermediate angles of approximately 90° on the lateral surface of the prism.

23. The airbag module according to claim 13, wherein an envelope is a right prism comprising two octagons as the base surface and the cover surface and comprises the at least two outflow openings, the at least two outflow openings situated radially to a straight line through center points of the two octagons, the at least two outflow openings situated at intermediate angles of approximately 180° on the lateral surface of the prism.

24. The airbag module according to claim 1, wherein the airbag module is a passenger airbag module.
